(19) United States
(12) Patent Application Publication
(10) Pub. No.: US 2002/0125035 A1
(43) Pub. Date: Sep. 12, 2002

(54) Elastic tensioning cable

(75) Inventor: Christophe Bezault, Pollionnay (FR)

Correspondence Address: BROWDY and NEIMARK, SUITE 300, 624 Ninth Street N.W., WASHINTON, DC, 20001-5303, US

(73) Assignee: TISSAGE ET ENDUCTION SERGE FERRARI SA, SAINT JEAN DE SOUDAIN (FR)

(21) Appl. No.: 10/092,477

(22) Filed: Mar. 8, 2002

(30) Foreign Application Priority Data
Mar. 8, 2001 (FR) 01 03175

(51) Int. Cl. H01B 7/00

(52) U.S. Cl. 174/110 R

(57) ABSTRACT

Elastic tensioning cable, which is made of a polysiloxane.

### TECHNICAL FIELD

The invention relates to an elastic cable which may especially be used for tensioning textile fabrics used as architectural elements.

For example, they may be coverings made of stretched fabric, or else a cladding.

A preferred application of the invention is therefore for tensioning and for holding out textile fabrics, but the invention relates more specifically to an elastic tensioning cable which can be used in very many ways.

### PRIOR ART

Many buildings have structures made of stretched fabric which are used as cladding, partitioning or as coverings. Thus, some swimming pools are equipped with a covering made of stretched fabric, generally coated with polyvinyl chloride. This stretched fabric is linked to one or more peripheral sections or to a fixed frame. The link between the fabric and the fixed frame is effected by means of elastic tensioning cables which, because of their elasticity properties, tension the fabric.

Elastic tensioning cables of known type generally consist of a core based on rubber yarns and of a textile sheath, generally formed from braided yarns. More specifically, the rubber yarns are generally bases on a natural latex and are combined in a bundle in order to form the necessary diameter.

This bundle of natural latex yarns is protected by a braided sheath, generally made of polypropylene, polyethylene, polyamide, polyester or cotton. This sheath protects the latex yarns from mechanical damage that might arise when the cable is subjected to high mechanical stresses.

Now, in general, when the cable is used in aggressive atmospheres the latex yarns have been found to have a low resistance to various external factors, such as especially ultraviolet radiation, or else chemical attack. This is the case, for example, near the sea, because of the corrosive action of salt on the latex.

The latex yarns of cables used for tensioning swimming pool covers are also observed to degrade since the chlorinated derivatives emanating from the swimming pool have a corrosive action on the latex yarns. In practice, this degradation results in softening of the latex yarns, which lose their elastic properties and even reach the point where they disintegrate as soon as they are compressed. The cable thus loses all its elasticity properties, and a loss of tension in the fabric is therefore observed, which therefore produces surface defects.

When the latex is highly degraded, it is the peripheral sheath which by itself holds out the fabric, hence increasing the risk of the latter dropping. Furthermore, this degradation is particularly pernicious since it is generally masked by the sheath and is only revealed when the cable is practically no longer of use, or worse when it breaks.

A first problem that the invention aims to solve is that of the resistance of the tensioning cables to various types of aggressive chemical atmospheres.

It has already been proposed to provide the tensioning cables with a double braid sheath. However, this solution is unsatisfactory since a double sheath is not actually gastight.

Moreover, another problem that arises with tensioning cables sheathed with a textile braid is the fact that any damage to a cable exposes the internal latex yarns. However, although such damage might not be a problem, in that the cable continues to fulfill its mechanical functions, it does result in a relatively visible surface defect, especially when the braid sheath has a different color from that of the latex yarns.

Furthermore, the tensioning cables used hitherto include a braided sheath and therefore require special handling operations in order to be butt-jointed. This is because, since the braided sheath and the elastic yarns do not have the same elongation properties, it is necessary to block the sheath with respect to the latex yarns in order to be able to produce the various butt joints.

It will be understood that these handling operations are relatively time-consuming and also generate certain surface defects on the cable.

### SUMMARY OF THE INVENTION

The invention therefore relates to an elastic tensioning cable.

According to the invention, this cable is made from a polysiloxane.

In other words, the invention consists in producing a tensioning cable from a polysiloxane or a silicone, which may advantageously be obtained by extrusion.

Thus, the elastic cable according to the invention is composed entirely of a silicone material, generally known for its high hydrophobicity and more generally its high chemical inertness. This is because silicone materials are widely used in medical fields for their good chemical inertness properties. They are also used as seals, because of their good adhesion properties. Silicones are also used for their heat resistance, especially as sheaths for electrical wires exposed to high temperatures.

According to the invention, the silicone is therefore used for its elasticity properties under tension, properties which are not employed as such in the prior art.

The elastic tensioning cable according to the invention is therefore in the form of a rod free of any external protective layer.

In practice, the cable may advantageously also incorporate colored pigments, making it possible to obtain a bulk-colored cable. Thus, if a notch were to be made in the cable, this would not expose a differently colored material but, on the contrary, an internal region having the same color as that appearing on the outside of the cable.

The cable may have cross sections highly varied in shape, and especially a circular cross section, a flat rectangular cross section or, more generally, a cross section matched to a particular application. Thus, a circular cross section may have a diameter dependent on the elastic forces that the cable must exert. This diameter may vary from a few millimeters to two centimeters. More generally, it is between 8 and 12 mm.

The cable used in this way may be especially combined with fastening means present at least at one of its ends. This cable may therefore be used to produce expanders of the type known by the brand name “SANDOW” (a bungee cord).

The cable may also be used for applications in which a fabric needs to be tensioned. It may therefore be employed to tension a fabric with respect to a fixed frame in order to form a covering or a cladding. It may also be used to tension the tarpaulins of truck trailers.

### BRIEF DESCRIPTION OF THE FIGURES

The manner of implementing the invention and the advantages which stem therefrom will become clearly apparent from the description of the embodiment which follows, supported by the single appended FIGURE illustrating a detail of the fastening and the tensioning of a fabric with respect to a frame.

### MANNER OF REALIZING THE INVENTION

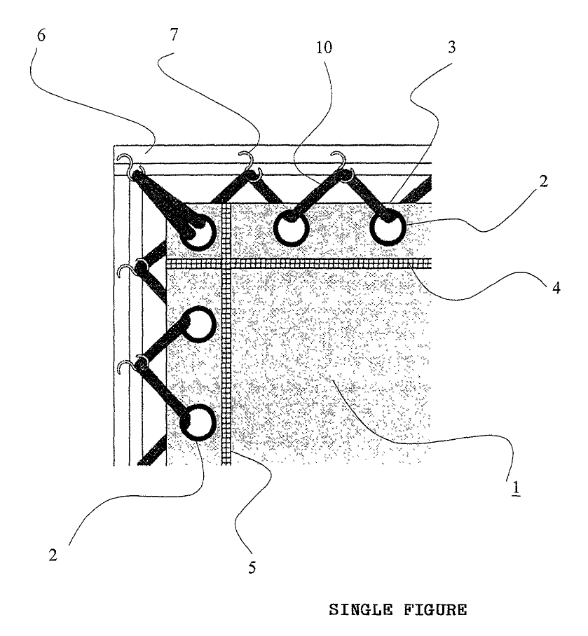

FIG. 1 illustrates a detail of the fastening of a tensioned fabric to a fixed frame.

More specifically, this tensioned fabric (1) possesses a plurality of eyelets (2) arranged around the periphery (3) of the fabric. These various eyelets are arranged at regular intervals over a welt produced by bonding or stitching (4, 5) around the periphery of the fabric. The eyelets are thus placed in a double thickness of fabric.

This fabric is stretched with respect to a frame (6) which is provided with hooks (7) or more generally with regions allowing the tensioning cable (10) to pass through them. In practice, the frame may be produced from independent sections fixed to the walls of the building. It may also form an independent frame consisting of various sections joined together.

According to the invention, this tensioning cable (10) is made from a silicone.

Good results have been obtained using an elastic cable made from the silicone sold under the brand name “RHODORSIL” MF 360U by Rhodia.

This heat-curable silicone is extruded to the desired diameter, for example to a diameter of 9 mm. It is then crosslinked by means of a peroxide, by being subjected to a temperature of 200° C. for a few minutes. It is then annealed for several hours.

Elasticity tests were carried out and gave the following results.

Thus, for a cable made from the aforementioned silicone and having a diameter of 9 mm, various elongation tests were performed, by measuring the return force developed by the cable, taken over a length of 10 cm at rest.

Thus, the force developed when the cable portion undergoes an elongation of 40% is 3.7 decanewtons. When the cable portion undergoes an elongation of 100%, the elastic force which is exerted by the cable is 12.75 decanewtons.

The elongation at break of this cable is greater than 200%.

Of course, the invention is not limited to the single embodiment described above; rather it encompasses many other variants with regard to formulation, to incorporation of pigmenting fillers and to dimensions.

It is also possible to obtain a cable by coextruding silicones of different formulations. In this case, it is possible to adjust the shape of the steepness curve.

It is apparent from the foregoing that the elastic tensioning cable according to the invention has many advantages, in particular, apart from its high elasticity, a high chemical inertness and hence resistance to many environments in which the latex is usually attacked, such as wet environments, hot environments, chlorinated environments or environments exposed to strong ultraviolet radiation.

It also has the advantage of being very fire resistant.

Used as a tensioning cable, it also has the advantage of not requiring a protective sheath, thereby simplifying the fitting operations. It furthermore has the advantage of being able to be bulk-colored, allowing it to come in different versions with the same ranges of colors as those used for the fabrics that it is able to tension. Moreover, because of the absence of an external sheath, a simple visual check allows possible damage to be detected.

### Industrial Applications

The cable according to the invention can be used in many applications, and may especially serve to form tensioners also known as “SANDOW” (bungee cords), with the very great variety of uses that are known.

It may also serve for tensioning fabrics, tarpaulins or, more generally, textile structures or the like.

It has especially one very particular application for forming a tensioned covering, a cladding or a partition.

It may also be used in the field of water sports.

1. An elastic tensioning cable, which is made of a polysiloxane.

2. The cable as claimed in claim 1, which is obtained by extrusion.

3. The cable as claimed in claim 1, which incorporates colored pigments.

4. The cable as claimed in claim 1, which has a circular cross section.

5. The cable as claimed in claim 4, wherein the circular cross section has a diameter of between 6 and 15 mm.

6. The cable as claimed in one of claims 1 to 6, which is provided with fastening means at least at one of its ends.

7. A covering made from a tensioned fabric, wherein said fabric is tensioned with respect to a fixed frame by a cable as claimed in one of claims 1 to 6.

8. A cladding made from a tensioned fabric, wherein said fabric is tensioned with respect to a fixed frame by a cable as claimed in one of claims 1 to 6.
